(19) United States
(12) Patent Application Publication
(10) Pub. No.: US 2026/0159927 A1
(43) Pub. Date: Jun. 11, 2026

(54) A WEAR RESISTANT ALLOY

(71) Applicant: UDDEHOLMS AB, HAGFORS (SE)

(72) Inventor: Magnus TIDESTEN, Hagfors (SE)

(21) Appl. No.: 18/706,983

(22) PCT Filed: Nov. 7, 2022
(86) PCT No.: PCT/SE2022/051020

§ 371 Date: May 2, 2024

(30) Foreign Application Priority Data
Nov. 5, 2021 (SE) 2130297-1

(51) Int. Cl. C22C 38/34; C22C 38/00; C22C 38/02; C22C 38/04; C22C 38/22; C22C 38/30; C22C 38/32

(52) U.S. Cl. CPC C22C 38/34; C22C 38/002; C22C 38/02; C22C 38/04; C22C 38/22; C22C 38/30; C22C 38/32

(57) ABSTRACT

An alloy consisting of, in weight % (wt. %): C 0.3-0.8, Si 0.1-1.8, Mn 0.1-1.3, Mo 15-23, B 1.1-2.8, Cr 2-9, Co 4-12, optional elements, and balance Fe apart from impurities.

### CROSS-REFERENCE TO RELATED APPLICATION(S)

This is a National Stage Entry into the United States Patent and Trademark Office from International Patent Application No. PCT/SE2022/051020, filed on Nov. 7, 2022, which relies on and claims priority to Swedish Patent Application No. 2130297-1, filed on Nov. 5, 2021, the entire contents of both of which are incorporated herein by reference.

### FIELD OF THE INVENTION

The invention relates to a wear resistant steel alloy. The alloy is alloyed with boron and molybdenum in order to form hard phase particles. The invention also relates to a fine blanking tool or a powder pressing tool or a stamping tool or a cutting tool comprising the alloy.

### BACKGROUND OF THE INVENTION

Nitrogen and vanadium alloyed powder metallurgy (PM) tool steels attained a considerable interest because of their unique combination of high hardness, high wear resistance and excellent galling resistance. These steels have a wide range of applications where the predominant failure mechanisms are adhesive wear or galling. Typical areas of application include blanking and forming, fine blanking, cold extrusion, deep drawing and powder pressing. The basic steel composition is atomized, subjected to nitrogenation and thereafter the powder is filled into a capsule and subjected to hot isostatic pressing (HIP) in order to produce an isotropic steel. A high-performance steel produced in this way is described in WO 00/79015 A1.

Although the known steel has a very attractive property profile there is a continuous strive for improvements of the tool material in order to further improve the surface quality of the products produced as well as to extend the tool life, in particular under severe working conditions, requiring a good resistance against galling and abrasive wear at the same time. In many applications it is a desire that the material also should be corrosion resistant.

Wear resistant alloys, which are alloyed with boron in order to form hard phase particles are also known in the art. U.S. Pat. No. 4,318,733 discloses commercial tool steels modified with 0.1-1.5 wt. % B. WO2016100374 A1, WO2018232618 A1, CN104846364 A and CN102619477 A are further examples of tool steels alloyed with boron. Lentz et al. (steel research int. 2020, Vol. 91, Issue 5) has published results concerning microstructures and properties of Boron-alloyed tool steels containing Mo.

WO2016099390 A1 discloses a boron and molybdenum containing wear resistant alloy comprising double borides of the type M₂M′ B₂, where M and M′ stand for metals of the multiple boride, wherein M is Mo and M′ is Fe and/or Ni. According to WO2016099390 A1, a preferred maximum content of Co is 2%, since it is expensive and make scrap handling more difficult, and it is mentioned that Co need not to be deliberately added.

### SUMMARY OF THE INVENTION

The object of the present invention is an alloy having an improved property profile for advanced forming applications such as fine blanking. The steel should also be well suited for gear cutting tools and end mills.

Another object of the present invention is to provide a powder metallurgy (PM) produced alloy having improved wear resistance with respect to both abrasive wear and adhesive wear.

The foregoing objects, as well as additional advantages are achieved to a significant measure by providing an alloy having a composition and microstructure as set out herein.

The invention is defined in the claims.

### BRIEF DESCRIPTION OF THE DRAWINGS

FIG. 1 shows the microstructure of the alloy in soft annealed condition.

FIG. 2 shows the microstructure of the alloy after hardening and tempering.

FIG. 3 shows the microstructure of a cast specimen of the invention.

FIG. 4 shows the microstructure of a cast reference steel.

### DETAILED DESCRIPTION OF EMBODIMENT(S) OF THE INVENTION

The present invention relates to an alloy comprising a hard phase consisting mainly of multiple borides of the type M₂M′B₂. However, the boride may contain substantial amounts of one or more of the other boride forming elements like Cr, Mo, W, Ti, V, Nb, Ta, Hf and Co.

However, in the following the double boride will be referred to as Mo₂FeB₂ because the alloy is Fe-based. However, the boride also may contain Ni and one or more of the boride-forming elements mentioned above.

The size of the hard phase particles may be determined by microscopic image analysis. The size thus obtained is the diameter corresponding to the diameter of a circle with the same projected area as the particle, the Equivalent Circle Diameter (ECD).

The importance of the separate elements and their interaction with each other as well as the limitations of the chemical ingredients of the claimed alloy are briefly explained in the following. All percentages of the chemical composition of the steel are given in weight % (wt. %) throughout the description. Upper and lower limits of the individual elements can be freely combined within the limits set out in the claims. The arithmetic precision of the numerical values can be increased by one or two digits for all values given in the present application. Hence, a value reported as e.g. 0.1% can also be expressed as 0.10 or 0.100%. The amount of the phases is given in volume % (vol. %). Upper and lower limits of the individual elements can be freely combined within the limits set out in the claims.

### Carbon (0.3-0.8%)

Carbon is important for the hardening in tool steels. Preferably, the carbon content is adjusted in order to obtain 0.4-0.6% C dissolved in the matrix at the austenitizing temperature resulting in a high strength matrix after quenching. The austenitizing temperature is preferably 1050-1120° C. In any case, the amount of carbon should be controlled such that the amount of carbides of the type M₂₃C₆, M₇C₃, M₆C, M₂C and MC in the steel is limited. The upper limit is 0.8% and may be set to 0.75%, 0.70%, 0.65%, 0.60% or 0.55%.

### Chromium (2-9%)

Chromium is commonly present in Fe-based alloys in order to provide a sufficient hardenability. For achieving a good hardenability it is desirable to have at least 2% Cr, preferably 2.5%, %, 3%, 3.5% or 4% dissolved in the matrix. Cr is preferably higher than 3% for providing a good hardenability in large cross sections during heat treatment. If the chromium content is too high, this may lead to the formation of undesired carbides, such as M₇C₃. In addition, this may also increase the propensity of retained austenite in the microstructure. The lower limit may be set to 3.0%, 3.2%, 3.4%, 3.6%, 3.8%, 4.0% or 4.2%. The upper limit may be set to 7.0%, 6.5%, 6.0%, 5.4%, or 4.6%.

### Molybdenum (15-25%)

Mo is the main element forming the hard boride. In the present invention, a high amount of Molybdenum is used in order to obtain a desired precipitation of the boride Mo₂FeB₂ in an amount of 15-35 vol. %. Molybdenum shall be present in an amount of at least 15%. The lower limit may be 16%, 17% or 18%. The upper limit is 25% in order to avoid problem with brittleness. The upper limit may be set to 24%, 23% or 22%.

Mo in an amount of at least 10% has been reported to have a favourable effect on the hardenability and for attaining a good secondary hardening response (Lentz et al., steel research int. 2020, Vol. 91, Issue 5). For this reason, it is preferred that the amount of Mo remaining in the matrix after quenching form 1100° C. is 1.5-2.5%. However, too much Mo dissolved in the matrix after hardening may result in too high an amount of retained austenite and a reduced hardness. Hence, it is desirable to balance the Mo content to the Mo-containing hard boride phases such that the matrix does not contain more than 4% or 3.5% dissolved Mo, preferably not more than 3.2% Mo. A preferred range of dissolved Mo may be set to 2.1-3.1%. The ratio Mo/B may therefore preferably be adjusted to the range 6-18, preferably 8-15, more preferably 9-12. Another reason for balancing the ratio Mo/B is to avoid too much surplus of Molybdenum, which may lead to the formation of the hexagonal phase M₂C, where M mainly is Mo and/or V. M₆C may also be formed, where M mainly is Mo and/or V. The amount of the phase M₆C and/or M₂C may be limited to ≤5 vol %, preferably ≤4 vol %, more preferably ≤3, or even further such as ≤1.5 vol. %≤1 vol. %, or ≤0.5 vol. %.

### Boron (1.1-2.8%)

Boron, which is the hard phase-forming non-metallic element, should be at least 1.1% so as to provide the minimum amount of 15% hard phase Mo₂FeB₂. The amount of B is limited to 2.8% for not making the alloy to brittle. The lower may be set to 1.2%, 1.3%, 1.4%, 1.5%, 1.6%, 1.7%, 1.8%, 1.9% or 2.0%. The upper limit may be set to 2.7%, 2.6%, 2.5%, 2.4%, 2.3% or 2.2%.

### Tungsten (≤5%)

Tungsten may be present in an amount of up to 5%. The effect of tungsten is similar to that of Mo. However, for attaining the same effect it is on a weight % basis necessary to add twice as much W than Mo. Tungsten is expensive and it also complicates the handling of scrap metal. The maximum amount may therefore be limited to 3%, 2.5%, 2%, 1.9%, 1.8%, 1.7%, 1.6%, 1.5%, 1%, 0.5% or 0.3%.

### Vanadium (≤5%)

Vanadium forms evenly distributed primary and secondary precipitated carbides of the type MC. In the inventive steel M is mainly vanadium but Cr and Mo may be present to some extent. The maximum addition of V is restricted to 5% and the preferred maximum amount is 1.5%. However, in the present case V is mainly added for obtaining a desired composition of the steel matrix before hardening. The addition may therefore be limited to 1.0%, 0.9%, 0.8%, 0.7%, 0.6% or 0.5%. A lower limit may be set to 0.05%, 0.1%, 0.12%, 0.14%, 0.16%, 0.15% or 0.2%. A preferred range is 0.1-0.5% V.

### Niobium (≤5%)

Niobium is similar to vanadium in that it forms MC. However, for attaining the same effect it is necessary to add twice as much Nb as V on a weight % basis. Nb also results in a more angular shape of the MC. Hence, the maximum addition of Nb is restricted to 5% and the preferred maximum amount is 1.5%. The upper limit may be set to 1%, 0.5%, 0.3%, 0.1% or 0.05%.

### Silicon (0.1-1.8%)

Silicon may be used for deoxidation. Si also increases the carbon activity and is beneficial for the machinability. For a good deoxidation, it is preferred to adjust the Si content to at least 0.1%. Si is therefore preferably present in an amount of 0.1-1.5%. The lower limit may be set to 0.15%, 0.2%, 0.25%, 0.3%, 0.35% or 0.4%. However, Si is a strong ferrite former and should be limited to 1.8%. The upper limit may be set to 1.5%, 1%, 0.8%, 0.7% or 0.6%. A preferred range is 0.2-0.8%.

### Manganese (0.1-1.3%)

Mn is an austenite former and increases the solubility for nitrogen in the alloy. Mn may therefore be present in amounts of up to 1.3%. Manganese contributes to improving the hardenability of steel and together with sulphur manganese contributes to improving the machinability by forming manganese sulphides. Manganese may therefore be present in a minimum content of 0.1%, preferably at least 0.2%. At higher sulphur contents manganese prevents red brittleness in the steel. The upper limit may be set to 1.2%, 1.0%, 0.8% or 0.6%. However, preferred ranges are 0.2-0.8% and 0.2-0.6%.

### Nickel (≤10%)

Nickel is optional but may be deliberately added in amounts up to 10%. Nickel share many properties with Fe and can therefore partially substitute iron in the steel. Ni may preferably be deliberately added in an amount of not more than 10%, 8%, 7% or 5%. It gives the steel a good hardenability and toughness. Too high amounts of Ni may induce austenite which is not a desired phase according to the invention. Because of the expense, the nickel content is preferably limited. If not added deliberately Ni may be tolerated as an impurity up to 3%. The upper limited may be set to 2%, 1.0% or 0.3%.

### Iron

Iron is used as balance.

### Copper (≤5.0%)

Cu is an optional element, which may contribute to increasing the hardness and the corrosion resistance of the steel. The upper limit may be 4%, 3%, 2%, 1%, 0.9%, 0.7%, 0.5%, 0.3% or 0.1%. However, it is not possible to extract copper from the steel once it has been added. This drastically makes the scrap handling more difficult. For this reason, copper is normally not deliberately added.

### Cobalt (4-12%)

Co is present in an amount of not more than 12%. Co dissolves in iron and strengthens it whilst at the same time imparting high temperature strength. Co increases the Mₛ temperature and permits higher quenching temperatures and is known to increase the red hardness in high speed steels. Co enhances the Curie temperature, lower the diffusivity, and decreases the coarsening rate of the carbides and/or nitrides hard particles. It is therefore believed that Co increases the tempering resistance. Co can partly substitute Fe in the Mo₂FeB₂ boride. Experiments have surprisingly shown that the addition of Co may increases the size of the primary borides, MozFeB₂. An increased boride size may be beneficial for abrasive resistance. The addition of Co further suppresses the formation of austenite. However, Co is expensive. The upper limit may therefore be set to 11%, 10% or 9%. The lower limit may be 4, 5, 6, or 7%.

### Phosphorous (≤0.1%)

P is an impurity element and a solid solution strengthening element. However, P tends to segregate to the grain boundaries, reduces the cohesion and thereby the toughness. P is therefore normally limited to ≤0.05%.

### Sulphur (≤0.5%)

S contributes to improving the machinability of the steel. At higher sulphur contents there is a risk for red brittleness. Moreover, a high sulphur content may have a negative effect on the fatigue properties of the steel. The steel shall therefore contain ≤0.5%, preferably ≤0.1, more preferably ≤0.03%.

### Nitrogen (≤0.5%)

Nitrogen is an optional component. N can be present in solid solution but may also be found in the hard phase particles together with B and C. The upper limit may be 0.4%, 0.3%, 0.2%, 0.15%, 0.1%, 0.05% and 0.03%.

### Aluminium (≤0.1%)

Al can be added in order to deoxidise the alloy. The upper limit is 0.1% but may be set to 0.08%, 0.06% or 0.05%.

The lower limit for deoxidation may be set to 0.005%, 0.01% or 0.03%.

The steel may be used in powder form for additive manufacturing (AM), in particular by use of commercial units for laser melting or electron beam melting. It can thus be used for providing a wear resistant cladding on a substrate. The powder can also be used for flame spraying, hard facing and the like. Examples of suitable additive manufacturing methods includes but is not limited to: Selective laser melting (SLM), Direct Metal Deposition (DMD), Direct metal laser sintering (DMDS), Electron Beam Additive Manufacturing.

The alloy consists of in weight % (wt. %):

| | |
|---|---|
| C | 0.3-0.8 |
| Si | 0.1-1.8 |
| Mn | 0.1-1.3 |
| Mo | 15-23 |
| B | 1.1-2.8 |
| Cr | 2-9 |
| Co | 4-12 |

### Optionally

| | |
|---|---|
| V | ≤5 |
| Nb | ≤5 |
| Cu | ≤5 |
| W | ≤5 |
| S | ≤0.5 |
| N | ≤0.5 |
| Al | ≤0.1 |
| Ni | ≤10 |

balance Fe apart from impurities.

The alloy can be produced by powder metallurgy, preferably by gas atomizing.

### Microstructure

A gas atomized alloy may comprise 15-35 volume % hard phase particles of at least one of borides, nitrides, carbides and/or combinations thereof. Preferably, at least 60% of the hard phase particles consist of Mo₂FeB₂ or Mo₂NiB₂ and at least 90% of the hard phase particles have a size of less than 5 μm. Preferably, at least 50% of the hard phase particles have a size in the range of 0.3-3 μm. It is also preferred that the Mo/B ratio is adjusted to the range of 6-18 and that the matrix of the alloy does not contain more than 4% Mo.

The steel composition and heat treatment can be selected to give the steel a tempered martensitic matrix. The amount of retained austenite in a martensitic matrix may be restricted to 10 vol. %, 5 vol. % or 2 vol. %. The alloy may be made free of retained austenite in hardened and tempered condition. The hard phase particles may be embedded in the martensitic matrix.

Thus, the microstructure in hardened and tempered condition may comprise in vol %:

| | |
|---|---|
| hard phase particles | 15-35 |
| retained austenite | <10 |

balance tempered martensite.

The hard phase particles and the tempered martensite may e.g., be determined by using SEM (Scanning Electron Microscope) at a magnification of 1500 times. The retained austenite can be determined by an X-ray diffractometer using ASTM E975-13.

In the hardened and tempered condition, the alloy may achieve a hardness of more than 65 HRC. The hardness is affected by austenitizing conditions during hardening and the tempering conditions. A hardness of at least 68 HRC, preferably at least 69 HRC, most preferably at least 70 HRC may be achieved. Rockwell hardness may be determined by ASTM E18-00.

In the hardened and tempered condition, the alloy may have a compressive yield strength above 3000 MPa. Preferably in the range of 3200-4000 MPa, more preferably 3500-3900 MPa. The elastic modulus may be above 230000 MPa, preferably 240000-270000 MPa. The values can be derived from the methods described in ASTM E9-19 and ASTM E 111-17.

In soft annealed condition the alloy may have a hardness in the range of 250-400 HB, preferably 300-350 HB. Brinell hardness may be determined by ASTM E10-15.

The alloy may be manufactured through gas atomizing of a melt.

The powder may be sieved (e.g <500 μm) and filled in steel capsules and subjected to HIPing at temperatures in the range of 1000-1300° C., preferably 1100-1200° C. The holding time can e.g. be 1-3 hours and the pressure can e.g. be 90-150 MPa. The cooling rate can be <10° C./s, typically 1° C./s. The steel can be forged at 1000-1200° C. before soft annealing at 800-1000° C., typically around 900° C., with a cooling rate of 5-20° C./h down to 600-800° C. and thereafter cooling freely in air.

### Example 1

An alloy A was melted and subjected to gas atomizing.

The atomized alloy had the following composition in weight %:

| | |
|---|---|
| C | 0.51 |
| Si | 1.06 |
| Mn | 0.29 |
| Cr | 4.21 |
| Mo | 17.34 |
| B | 1.59 |
| Ni | 0.04 |
| V | 0.26 |
| W | 0.06 |
| Cu | 0.13 |
| Co | 8.52 |
| N | 0.02 |
| P | 0.013 |
| S | 0.009 |
| Fe | balance apart from impurities. |

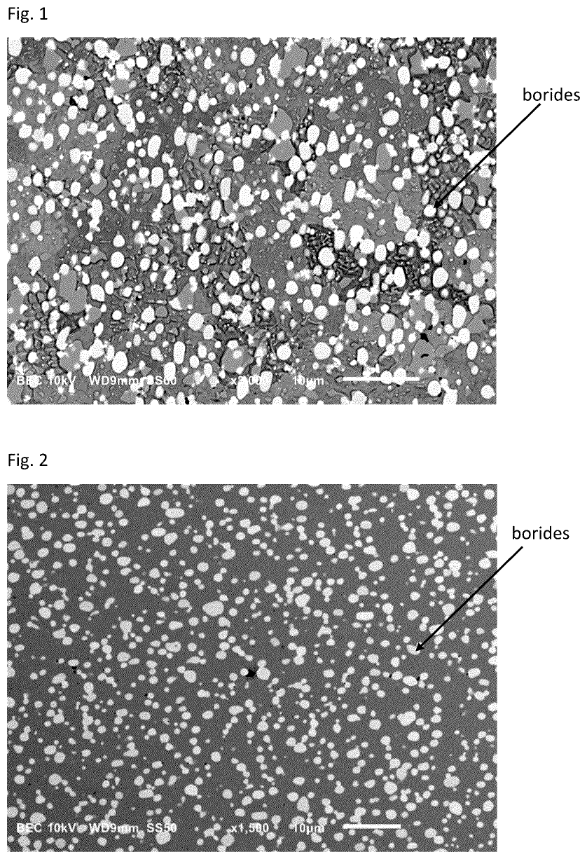

The powder was sieved to <500 μm, filled in steel capsules and subjected to HIPing was performed at a temperature of 1150° C., the holding time was 2 hours and the pressure 110 MPa. The cooling rate was <1° C./s. The material thus obtained was forged at 1100° C. to the dimension 20×30 mm. Soft annealing was performed at 900° C. with a cooling rate of 10° C./h down to 750° C. and thereafter cooling freely in air. In soft annealed condition the hardness was determined to be 335 HB. FIG. 1 shows the microstructure in the soft annealed condition, magnification 2000 times.

Hardening was performed by austenitizing at 1100° C. for 30 minutes in a vacuum furnace followed by high pressure gas quenching using nitrogen gas. The steel was subjected to tempering three times for 1 hour (3×1 h) at different temperatures. The result of the hardness testing after tempering is given in Table 1. The ductility, the compressive yield strength, and the Elastic modulus was determined for the steels tempered at 520° C. and 560° C., the results are shown in Table 1. The amount of retained austenite in a martensitic matrix was determined to be less than 2 vol. % for all tempering temperatures. FIG. 2 shows the microstructure after trice tempering at 560° C., magnification 1500 times. The microstructure contained 23% hard phase particles in a matrix of tempered martensite.

TABLE 1
Hardness as a function of the tempering
temperature after hardening from 1100° C.

| | | | Compressive | |
|---|---|---|---|---|
| Tempering | Hardness | Ductility | Yield strength | Elastic modulus |
| temperature (° C.) | (HRC) | (J) | Rc0.2 (MPa) | (MPa) |
| 510 | 69.8 | | | |
| 520 | 70.0 | 12.7 | 3768 | 245630 |
| 530 | 69.7 | | | |
| 540 | 69.0 | | | |
| 550 | 68.5 | | | |
| 560 | 68.0 | 14.9 | 3654 | 249847 |
| 570 | 67.0 | | | |

Accordingly, the best wear resistance and the highest compressive strength tempering at about 520° C. is recommended and if higher ductility is needed, then it is recommended to temper at about 560° C.

### Example 2

An alloy B was melted and subjected to gas atomizing.

The powder was sieved to <500 μm, filled in steel capsules and subjected to HIPing was performed at a temperature of 1100° C., the holding time was 4.5 hours and the pressure 100 MPa. The cooling rate was <1° C./s. The material thus obtained was forged at 1100° C. to a bar with diameter 142 mm. Soft annealing was performed at 900° C. with a cooling rate of 10° C./h down to 750° C. and thereafter cooling freely in air.

Hardening was performed by austenitizing at 1100° C. for 30 minutes in a vacuum furnace followed by high pressure gas quenching using nitrogen gas. The steel was subjected to tempering three times for 1 hour (3×1 h) at 560° C.

The atomized alloy had the composition in weight % according to B of Table 2. To commercial alloys were added as reference CPM® 15V and Vanadis® 8. The heat treatment of CPM® 15V and Vanadis® 8 according to Table 3.

TABLE 2

| Alloy | C | Si | Mn | Mo | B | Cr | Co | V | Fe |
|---|---|---|---|---|---|---|---|---|---|
| B | 0.51 | 0.46 | 0.29 | 18.2 | 1.89 | 4.18 | 8.75 | 0.28 | Bal. |
| CPM ® 15V | 3.4 | 0.9 | 0.5 | 1.3 | — | 5.25 | — | 14.5 | Bal. |
| Vanadis ® 8 | 2.3 | 0.4 | 0.4 | 3.6 | — | 4.8 | — | 8.0 | Bal. |

The abrasive resistance was tested in a modified pin on disc method against SiO₂ paper and Al₂O₃ paper. The weight loss per minute was determined. The results are shown in Table 3.

TABLE 3

| | | Hardness | Mg/min | Mg/min |
|---|---|---|---|---|
| Alloy | Heat treatment | HRC | SiO₂ | Al₂O₃ |
| B | 1100° C. + 560° C./3 × 1 h | 68.5 | 1.1 | 32.2 |
| CPM ® 15V | 1120° C. + 540° C./3 × 2 h | 61.4 | 2.7 | 36.0 |
| Vanadis ® 8 | 1100° C. + 540° C./3 × 1 h | 62.2 | 10.3 | 83.6 |

As can be seen the inventive alloy had significantly better abrasive resistance than the commercial grades CPM® 15V and Vanadis® 8.

### Example 3

The effect of cobolt addition was investigated. Cast specimen of alloy B and reference alloy C according to Table 4 were produced. The only difference between alloy B and C was the cobalt content.

TABLE 4

| | C | Si | Mn | Mo | B | Cr | Co | V | Fe |
|---|---|---|---|---|---|---|---|---|---|
| B | 0.5 | 0.5 | 0.3 | 18.3 | 1.9 | 4.2 | 8.8 | 0.3 | Bal. |
| C | 0.5 | 0.5 | 0.3 | 18.3 | 1.9 | 4.2 | — | — | Bal. |

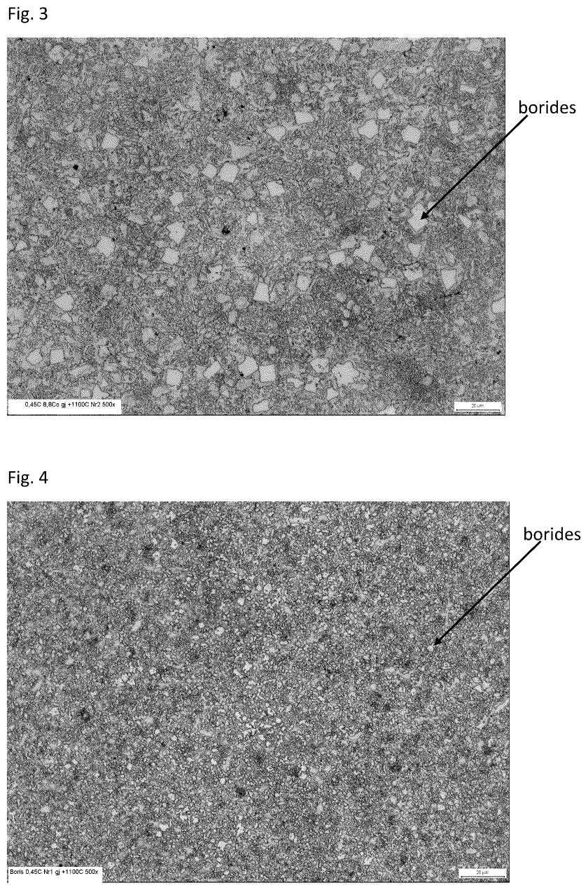

FIG. 3 disclose the microstructure of alloy B hardened at 1100° C. for 30 minutes in a vacuum furnace followed by high pressure gas quenching using nitrogen gas and thereafter tempered 3 times for 1 hour at 525° C. Hardness before tempering was 70 HRC and after tempering 70 HRC. The magnification in the figure is 500 times.

FIG. 4 disclose the microstructure of alloy C hardened at 1100° C. for 30 minutes in a vacuum furnace followed by high pressure gas quenching using nitrogen gas and thereafter tempered 3 times for 1 hour at 525° C. Hardness before tempering was 69 HRC and after tempering 66 HRC. The magnification in the figure is 500 times.

As can be derived from the comparison between B and C, the cobalt addition improved not only hardness but also tempering resistance. And further, from the comparison between FIGS. 3 and 4, it can visually be seen that the cobalt addition increased the size of the primary borides significantly in alloy B. The increased hardness and the increased size of primary borides is believed to be the reasons to the main reasons for the high abrasive resistance of alloy B.

The alloy of the present invention is useful for a wide range of applications. In particular, the steel is useful in applications requiring very high resistance against abrasive and/or adhesive wear such as fine blanking. The alloy is further suitable for cutting tools such as milling and threading tools, in particular end mills, gear cutting tools, thread mills. Another example of cutting tools are rotary cutters. The alloy is further suitable for stamping including lamination dies. The alloy is further suitable for powder pressing tools.

1. An alloy consisting of, in weight % (wt. %):

| | |
|---|---|
| C | 0.3-0.8 |
| Si | 0.1-1.8 |
| Mn | 0.1-1.3 |
| Mo | 15-23 |
| B | 1.1-2.8 |
| Cr | 2-9 |
| Co | 4-12 |

optionally

| | |
|---|---|
| V | ≤5 |
| Nb | ≤5 |
| Cu | ≤5 |
| W | ≤5 |
| S | ≤0.5 |
| N | ≤0.5 |
| Al | ≤0.1 |
| Ni | ≤10, |

and
balance Fe apart from impurities.

2. The alloy according to claim 1, which comprises at least one of the following components, in weight % (wt. %):

| | |
|---|---|
| C | 0.4-0.6 |
| Si | 0.2-1.3 |
| Mo | 16-23 |
| B | 1.2-2.4 |
| Cr | 3-8 |
| Co | 6-12 |
| V | ≤1.5 |
| Nb | ≤1.5 |
| W | ≤1 |
| S | ≤0.05, and/or |
| Ni | ≤5. |

3. The alloy according to claim 1, which comprises, in weight % (wt. %):

| | |
|---|---|
| C | 0.45-0.65 |
| Si | 0.4-1.2 |
| Mn | 0.2-0.5 |
| Mo | 15-23 |
| B | 1.4-2.2 |
| Cr | 3-6 |
| Co | 7-10 |
| V | 0.05-0.5, and |
| Ni | ≤1. |

4. The alloy according to claim 1, wherein the alloy is in the hardened and tempered condition and has a hardness of at least 68 HRC, preferably at least 69 HRC, most preferably at least 70 HRC.

5. The alloy according to according to claim 1, wherein the alloy fulfils at least one of the following conditions:
the alloy comprises 15-35 volume % hard phase particles,
the hard phase particles comprise at least one of borides, nitrides, carbides and/or combinations thereof,
at least 90% of the hard phase particles have a size of less than 5 μm and
at least 50% of the hard phase particles have a size in the range of 0.3-3 μm and at least 60% of the hard phase particles consist of Mo₂FeB₂ or Mo2NiB,
the matrix of the alloy does not contain more than 4% Mo, and/or
the alloy does not contain more than 5% retained austenite.

6. A fine blanking tool or a powder pressing tool or a stamping tool or a cutting tool comprising the alloy according to claim 1.
